(19) United States
(12) Patent Application Publication
(10) Pub. No.: US 2026/0122443 A1
(43) Pub. Date: Apr. 30, 2026

(54) TECHNIQUES FOR MINIMIZING MEMORY CONSUMPTION WHEN USING FILTERS FOR DYNAMIC CROSSTALK CANCELLATION

(71) Applicant: HARMAN INTERNATIONAL INDUSTRIES, INCORPORATED, Stamford, CT (US)

(72) Inventor: Alfredo FERNANDEZ FRANCO, Los Angeles, CA (US)

(21) Appl. No.: 19/005,620

(22) Filed: Dec. 30, 2024

Related U.S. Application Data
(60) Provisional application No. 63/617,140, filed on Jan. 3, 2024.

(51) Int. Cl. H04S 7/00

(52) U.S. Cl. CPC H04S 7/303; H04S 2420/01

(57) ABSTRACT

Various embodiments disclose a computer-implemented method comprising determining a new position and orientation of a user; updating, based on the new position and orientation of the user, a dimensional map, wherein the dimensional map includes a set of points in a multi-dimensional space and each point is associated with a corresponding transfer function; identifying, based on the new position and orientation of the user, a point in the updated dimensional map nearest to the new position and orientation of the user; configuring, based on at least the transfer function associated with the point nearest to the new position and orientation of the user, at least one crosstalk cancellation filter; generating a plurality of audio signals for a plurality of loudspeakers based on the at least one crosstalk cancelation filter; and transmitting the plurality of audio signals to the plurality of loudspeakers for output.

### CROSS-REFERENCE TO RELATED APPLICATIONS

This application claims benefit of the United States Provisional Patent Application titled “MINIMIZING MEMORY CONSUMPTION WHEN USING FILTERS FOR CROSSTALK CANCELATION,” filed Jan. 3, 2024, and having Ser. No. 63/617,140. The subject matter of this related application is hereby incorporated herein by reference.

### BACKGROUND

### Field of the Various Embodiments

Embodiments of the present disclosure relate generally to audio reproduction and, more specifically, to techniques for minimizing memory consumption when using filters for dynamic crosstalk cancellation.

### Description of the Related Art

Audio processing systems use one or more speakers to produce sound in a given space. The one or more speakers generate a sound field, where a user in the environment receives the sound included in the sound field. The one or more speakers reproduce sound based on an input signal that typically includes at least two channels, such as a left channel and a right channel. The left channel is intended to be received by the left ear of a user, and the right channel is intended to be received by the right ear of the user. Binaural rendering algorithms for producing sound using one or more speakers rely on crosstalk cancellation algorithms to ensure that the signals intended for the left ear are received by the left ear without interference from the other signals intended for the right ear, and vice versa. To do so, conventional crosstalk cancellation algorithms attempt to filter out interfering signals by characterizing the transmission paths of audio from speakers to the entrance of the ear canals of users based on measurements taken of a user at a specific location. In order to cover the vast range of potential positions and orientations that a user can be in, conventional audio systems implementing crosstalk cancellation store a very large number (e.g., hundreds, thousands, etc.) of predetermined filters. Once the position and orientation of the user is known, the conventional audio system will search the database of filters for the correct filter that corresponds to reducing or eliminating crosstalk from that position and orientation.

At least one drawback with conventional audio systems implementing crosstalk cancellation techniques is that the search time for the appropriate filter is constrained by the size of the filter database. The conventional audio systems desire accuracy, which leads to larger filter databases to cover more positions and orientations. However, as the size of the filter database increases, the search time for finding the correct filter that corresponds to reducing or eliminating crosstalk, also increases. Additionally, the amount of memory required to store the filter database and then search the database can be prohibitive for real-time, dynamic implementation of crosstalk cancellation. Many conventional audio systems are not equipped with the requisite amount of memory.

As the foregoing illustrates, what is needed in the art are more effective techniques for real-time searching of crosstalk cancellation filters when a listener changes positions.

### SUMMARY

Various embodiments disclose a computer-implemented method comprising: determining a new position and a new orientation of a user; updating, based on the new position and the new orientation of the user, a dimensional map, wherein the dimensional map includes a set of points in a multi-dimensional space and each point is associated with a corresponding transfer function; identifying, based on the new position and the new orientation of the user, a point in the updated dimensional map nearest to the new position and the new orientation of the user; configuring, based on at least the transfer function associated with the point nearest to the new position and the new orientation of the user, at least one crosstalk cancellation filter; generating a plurality of audio signals for a plurality of loudspeakers based on the at least one crosstalk cancelation filter; and transmitting the plurality of audio signals to the plurality of loudspeakers for output.

Further embodiments provide, among other things, one or more non-transitory computer-readable media and systems configured to implement the method set forth above.

At least one technical advantage of the disclosed techniques relative to the prior art is that, with the disclosed techniques, an audio processing system can minimize the amount of memory required for real-time, dynamic crosstalk cancellation. Furthermore, the audio processing system can implement real-time, dynamic crosstalk cancellation techniques faster than conventional techniques. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating an audio processing system, according to one or more embodiments.

FIG. 2 illustrates an example of how crosstalk is observed by a listener from an input signal that is produced by one or more speakers, according to one or more embodiments.

FIG. 3 illustrates an example of filters that perform crosstalk cancellation based upon an observed position and orientation of a listener within a three-dimensional space, according to one or more embodiments.

FIG. 4 illustrates an example dimensional map based on the starting position and orientation of a listener, according to one or more embodiments.

FIG. 5 illustrates an example dimensional map that has been updated based on the trajectory of the position and orientation of a listener, according to one or more embodiments.

FIG. 6 illustrates a flow chart of method steps for determining crosstalk cancellation filters when a listener changes position in real-time, according to one or more embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

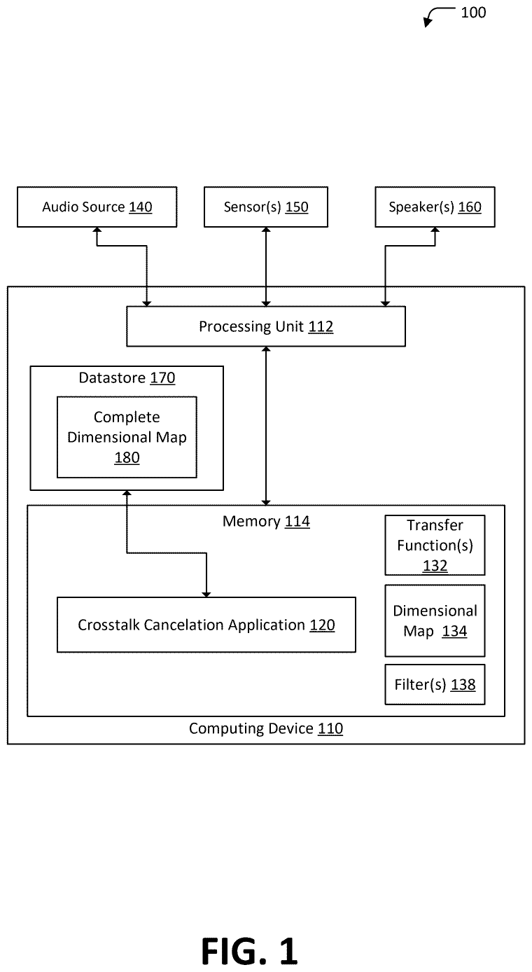

FIG. 1 is a schematic diagram illustrating an audio processing system 100 according to various embodiments. As shown, the audio processing system 100 includes, without limitation, a computing device 110, an audio source 140, one or more sensors 150, and one or more speakers 160. The computing device 110 includes, without limitation, a processing unit 112, a datastore 170, and memory 114. The datastore 170 stores, without limitation, a complete dimensional map 180. The memory 114 stores, without limitation, a crosstalk cancellation application 120, transfer functions 132, a dimensional map 134, and one or more filters 138.

In operation, the audio processing system 100 processes sensor data from the one or more sensors 150 to track the location of one or more listeners within the listening environment. The one or more sensors 150 track the position of the head of a listener in three-dimensional space as well as the pitch, yaw, and roll of the head, which is used to locate the relative location of the left ear and right ear, respectively, of the listener as the listener moves through the environment. For example, the one or more sensors 150 determine a starting position and orientation of the listener. Based upon the position and orientation of the listener within a three-dimensional environment, the crosstalk cancellation application 120 determines the dimensional map from the complete dimensional map 180. The crosstalk cancellation application searches the dimensional map 134 and selects one or more transfer functions 132 utilized for one or more filters 138 that are used to process the audio source 140 for playback by one or more speakers 160 associated with the audio processing system 100. Then, should the position of the head of the listener in a three-dimensional space change during playback of the audio source 140, the one or more sensors 150 determine a new position and orientation of the listener. The crosstalk cancellation application 120 then optionally use the new position and orientation of the listener to determine the trajectory of the listener based on the difference between the starting position and orientation of the listener and the new position and orientation of the listener. The crosstalk cancellation application 120 then updates the dimensional map 134 by loading points from the complete dimensional map 180 stored in data store 170 that are associated with positions and orientations around the new position and orientation of the listener or the trajectory of the listener. The crosstalk cancellation application 120 then uses a current position and/or orientation of the listener to determine the one or more transfer functions 132 that are associated with one or more points in the dimensional map 134 that are closest to the position and orientation of the listener. The crosstalk cancellation application 120 then uses the determined one or more transfer functions 132 to configure the one or more filters 138 that are used to process the audio source 140 for playback by one or more speakers 160 associated with the audio processing system 100 to reduce or eliminate crosstalk at the new position and orientation of the listener.

The computing device 110 is a device that drives speakers 160 to generate, in part, a sound field for a listener by playing back an audio source 140. In various embodiments, the computing device 110 is an audio processing unit in a home theater system, a soundbar, a vehicle system, and so forth. In some embodiments, the computing device 110 is included in one or more devices, such as consumer products (e.g., portable speakers, gaming, etc. products), vehicles (e.g., the head unit of a car, truck, van, etc.), smart home devices (e.g., smart lighting systems, security systems, digital assistants, etc.), communications systems (e.g., conference call systems, video conferencing systems, speaker amplification systems, etc.), and so forth. In various embodiments, the computing device 110 is located in various environments including, without limitation, indoor environments (e.g., living room, conference room, conference hall, home office, etc.), and/or outdoor environments, (e.g., patio, rooftop, garden, etc.).

The processing unit 112 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of processing units, such as a CPU configured to operate in conjunction with a GPU. In general, the processing unit 112 can be any technically feasible hardware unit capable of processing data and/or executing software applications.

The datastore 170 can be any technically feasible storage system with memory that is capable of storing the complete dimensional map 180. In various embodiments, the datastore include non-volatile memory, such as optical drives, magnetic drives, flash drives, or other storage. In some embodiments, the datastore 170 is external to the computing device 110, such as an external data store included in a network (“cloud storage”), which can supplement the computing device 110.

The complete dimensional map 180 includes a plurality of points that represent a position and orientation in a three-dimensional space (e.g., points within a six-dimensional space identified by x, y, and z position coordinates and three roll, pitch, and yaw orientations). The complete dimensional map 180 maps position relative to a reference position in a given environment. For example, the complete dimensional map can map a given position within a three-dimensional space, such as a vehicle interior, to filter parameters for one or more filters 138, such as one or more finite impulse response (FIR) filters. The complete dimensional map 180 further maps orientation relative to a reference orientation in the environment. The complete dimensional map 180 can be generated by conducting acoustic measurements in the three-dimensional space for filter parameters, such as transfer functions 132, that minimize or eliminate crosstalk. The complete dimensional map 180 is then saved on the audio processing system 100 via the datastore 170 and is used to configure filters 138 utilized by computing device 110 to minimize or eliminate crosstalk during playback of an audio source 140. In some embodiments, the complete dimensional map 180 includes specific coordinates relative to a reference point. For example, the complete dimensional map 180 can store the potential positions and orientations of the head of a listener as a distance and angle from a specific reference point. In some embodiments, the complete dimensional map 180 can include additional orientation information, such as pitch, yaw, and roll, that characterize the orientation of the head of the listener. The complete dimensional map 180 could also include as a set of angles (e.g., {μ, φ, ψ}) relative to a normal orientation of the head of the listener. In such instances, a respective position and orientation defined by a point in complete dimensional map 180 is associated with one or more transfer functions 132 utilized for a filter 138. In one example, the complete dimensional map 180 is structured as a set of points, each of which is associated with a particular position and orientation in an environment.

In some embodiments, the complete dimensional map 180 is preconfigured to include a very large number (e.g., hundreds, thousands, etc.) of points in six dimensions (e.g., three dimensions for position and three dimensions for orientation) or less. Each of the points is associated with one or more filters 138 and/or transfer functions 132 that can be utilized for each of the speakers 160 to reduce or eliminate crosstalk. In some embodiments, the complete dimensional map 180 is used by the crosstalk cancellation application 120 to generate or update dimensional map 134, based on positional and orientation data associated with a listener in an environment. For example, the crosstalk cancellation application 120 can generate the dimensional map 134 based on a subset of points in the complete dimensional map 180 that are within a predetermined distance threshold (e.g., 20 cm in each dimension) from a position and orientation of the listener in any technically feasible dimensional space. In another example, the crosstalk cancellation application 120 can generate the dimensional map 134 based on the entirety of points within the complete dimensional map 180. The crosstalk cancellation application 120 can then remove points in the dimensional map 134 that are outside a predetermined distance threshold (e.g., 20 cm in each direction) from a position and orientation of the listener in any technically feasible dimensional space.

In another example, the crosstalk cancellation application 120 can update the dimensional map 134 to include additional points in the complete dimensional map 180 (or remove points from the dimensional map 134) based on changes in position and orientation of the listener in any technically feasible dimensional space. Various embodiments can be included that determine which additional points in the complete dimensional map 180 to add or which additional points from the dimensional map 134 to remove. For example, in some embodiments, the crosstalk cancellation application can determine a trajectory of a user based on the difference in distance between one or more previous positions and orientations of the listener and one or more new positions and orientation of the listener. The trajectory can be used to anticipate a further position and orientation of the listener so the dimensional map 134 can be updated before the listener reaches that position and orientation. In some embodiments, the crosstalk cancellation application 120 can search the complete dimensional map 180 for additional points to update the dimensional map 134 by using graph theory branch and bound algorithms, such as the A* algorithm, AO* algorithm, nearest neighbors algorithm, or any other technically feasible algorithm that can search for additional points in the complete dimensional map 180 based on a heuristic measurement, such as a new position and orientation of the listener.

Memory 114 can include a random-access memory (RAM) module, a flash memory unit, or any other type of memory unit or combination thereof. The processing unit 112 is configured to read data from and write data to the memory 114. In various embodiments, the memory 114 includes non-volatile memory, such as optical drives, magnetic drives, flash drives, or other storage. In some embodiments, separate data stores, such as an external data stores included in a network (“cloud storage”) can supplement the memory 114. The crosstalk cancellation application 120 within the memory 114 can be executed by the processing unit 112 to implement the overall functionality of the computing device 110 and, thus, to coordinate the operation of the audio processing system 100 as a whole. In various embodiments, an interconnect bus (not shown) connects the processing unit 112, the memory 114, the speakers 160, the sensors 150, and any other components of the computing device 110.

The crosstalk cancellation application 120 determines the location of a listener within a listening environment and selects parameters for one or more filters 138, such as based on one or more transfer functions 132, to generate a sound field for the location of the listener. The transfer functions 132 are selected to minimize or eliminate crosstalk. The filters 138 compensate for the effects of the listening environment as modeled by transfer functions 132 so that the left channel is perceived by the left ear of the listener with minimal crosstalk from the right channel. Similarly, the filters 138 compensate for the effects of the listening environment as modeled by the transfer functions 132 so that the right channel is perceived by the right ear of the listener with minimal crosstalk from the left channel. In various embodiments, the crosstalk cancellation application 120 utilizes sensor data from sensors 150 to track the position of the listener, and specifically the head of the listener, as the listener moves in the environment. The crosstalk cancellation application determines the dimensional map 134 from a subset of points in the complete dimensional map 180 associated with the starting position and orientation of the listener.

Based upon one or more new position and orientation of the listener, crosstalk cancellation application 120 updates the dimensional map 134 by loading points from the complete dimensional map 180 stored in data store 170 that are associated with positions and orientations around the one or more new position and orientation of the listener or a trajectory of the listener. The crosstalk cancellation application 120 determines the one or more transfer functions 132 that are associated with one or more points in the dimensional map 134 that are closest to the new position and orientation of the listener. The crosstalk cancellation application 120 selects appropriate filters 138 based on the transfer functions 132 that are utilized to process the audio source 140 for playback. In some embodiments, the crosstalk cancellation application 120 sets the parameters for multiple filters 138 corresponding to multiple speakers 160. For example, a first transfer function 132 can be utilized for a first filter 138 that is utilized for audio played back by a first speaker 160, and a second transfer function 132 is utilized by a second filter 138 that is utilized for audio played back by a second speaker 160. In other embodiments, a filter network is utilized such that a signal used to drive each speaker 160 is passed through a network of multiple filters. Additionally or alternatively, the crosstalk cancellation application 120 tracks the positions and orientations of multiple listeners.

In various embodiments, the crosstalk cancellation application 120 determines a position and orientation of the listener based on data from sensors 150 and identifies transfer functions 132 or other filter parameters for filters 138 corresponding to each speaker 160. The crosstalk cancellation application 120 then updates the filter parameters for a specific speaker (e.g., a first filter 138(1) for a first speaker 160(1)) when the head of the listener moves. For example, the crosstalk cancellation application 120 can initially generate filter parameters for a set of filters 138. Upon determining that the head of listener has moved to a new position or orientation, the crosstalk cancellation application 120 then determines whether any of the speakers 160 require updates to the corresponding filters 138. The crosstalk cancellation application 120 updates the filter parameters for any filter 138 that requires updating. In some embodiments, crosstalk cancellation application 120 generates each of the filters 138 independently. For example, upon determining that a listener has moved, the crosstalk cancellation application 120 can update the filter parameters for a filter 138 (e.g., 138(1) for a specific speaker 160 (e.g., 160(1)). Alternatively, the crosstalk cancellation application 120 updates multiple filters 138.

The filters 138 include one or more filters that modify an input audio source 140. In various embodiments, a given filter 138 modifies the input audio signal by modifying the energy within a specific frequency range, adding directivity information, and so forth. For example, the filter 138 can include filter parameters, such as a set of values that modify the operating characteristics (e.g., center frequency, gain, Q factor, cutoff frequencies, etc.) of the filter 138. In some embodiments, the filter parameters include one or more digital signal processing (DSP) coefficients that steer the generated soundwave in a specific direction. In such instances, the generated filtered audio signal is used to generate a soundwave in the direction specified in the filtered audio signal. For example, the one or more speakers 160 reproduce audio using one or more filtered audio signals to generate a sound field. In some embodiments, the crosstalk cancellation application 120 sets separate filter parameters, such as selecting a different transfer function 132 for separate filters 138 for different speakers 160. In such instances, one or more speakers 160 generate the sound field using the separate filters 138. For example, each filter 138 can generate a filtered audio signal for a single speaker 160 within the listening environment.

Transfer functions 132 include one or more transfer functions that are utilized to configure one or more filters 138 selected by crosstalk cancellation application 120 to process an input signal, such as a channel of the audio source 140, to produce an output signal used to driver a speaker 160. Different transfer functions 132 are utilized depending upon the position and orientation of a listener in a three-dimensional space.

In some embodiments, the dimensional map 134 is preconfigured to only include a subset of points in the complete dimensional map 180 within a predefined range (e.g., 50 cm, 20 cm, 10 cm, etc.) from the starting position and orientation of the listener in each dimension or a predetermined number of points that are closest to the starting position and orientation of the listener. For example, in the case of a three-dimensional map and a predefined range of 20 cm, if the starting position and orientation of the listener is at coordinate (5, 10, 12), the three-dimensional map is preconfigured to only include points within the range of (−20, −10, −12) to (25, 30, 32). Then, should the position of the head of the listener in a three-dimensional space change during playback of the audio source 140, the one or more sensors 150 determine a new position and orientation of the listener. In another example, the crosstalk cancellation application 120 can update the dimensional map 134 based on the points within the complete dimensional map 180. The crosstalk cancellation application 120 can then remove points in the dimensional map 134 that are outside a predetermined distance threshold (e.g., 20 cm in each direction) from a position and orientation of the listener in any technically feasible dimensional space.

Additionally, and/or alternatively, the crosstalk cancellation application 120 can use a trajectory of the listener to determine the points from the complete dimensional map 180 to include in the dimensional map 134. The trajectory can be determined based on a difference between a starting position and orientation of the listener and the new position and orientation of the listener or by fitting a spline or other curve to recent positions and orientations of the listener. Based on the trajectory of the listener, the new position and orientation of the listener can be predicted, the crosstalk cancellation application 120 updates the dimensional map 134 to narrow the total number of points in the dimensional map 134 to the one or more transfer functions of transfer functions 132 expected to be along the trajectory of the listener and/or near the projected new position and orientation of the listener. In the embodiment where the initial dimensional map 134 includes a very large number of points, the crosstalk cancellation application 120 can remove points in the dimensional map 134 that are no longer around the determined trajectory. For example, in the three-dimensional case, if the listener started at coordinate (5, 10, 12) and moved 20 cm along the x-axis of the dimensional map 134, the crosstalk cancellation application 120 can remove all points from the dimensional map 134 outside the range of (5, 10, 12) to (25, 10, 12), thereby reducing the amount of points the crosstalk cancellation application 120 searches when determining the appropriate transfer functions given the new position and orientation of the listener.

Additionally, and/or alternatively, the crosstalk cancellation application 120 can search the complete dimensional map 180 for additional points to update the dimensional map 134 by using graph theory branch and bound algorithms, such as the A* algorithm, AO* algorithm, nearest neighbors algorithm, or any other technically feasible algorithm that can search for additional points in the complete dimensional map 180 based on a heuristic measurement, such as the new position and orientation of the listener.

Crosstalk cancellation application 120 selects transfer functions 132 to configure filters 138, where the transfer functions 132 are identified by the dimensional map 134. The transfer functions 132 are used to configure filters 138 that process an audio source 140. Transfer functions 132 are identified based on a mathematical distance, such as a barycentric distance, of a set of points characterizing the position and orientation of the head of the listener to one or more of the points from the set of points in the dimensional map 134. In some embodiments, the transfer functions are the transfer functions associated with the point in the dimensional map closest to the new position and orientation 502 of the user. In some embodiments, the transfer functions are determined based on weighted sums of the transfer functions associated with the nearest set of points to the new position and orientation 502 of the user within the dimensional map 134. In one example, a given position and orientation of the listener is characterized by coordinates in six-dimensional space. In some embodiments, a nearest set of points to the coordinates is then identified within the dimensional map 134 using a graph search algorithm such as a Delaunay triangulation. A barycentric distance to each of the nearest set of points is determined, and the transfer functions 132 associated with the closest point in the dimensional map 134 are used to configure filters 138 that filter the audio source 140 that is played back.

As another example, a simplified approach to identifying transfer functions 132 includes reducing the number of dimensions of a position and orientation of the user that are considered when identifying a set of transfer functions specified by the dimensional map 134. As noted above, the dimensional map 134 includes a set of points in six-dimensional space to account for three parameters representing position and three parameters representing orientation. To reduce mathematical complexity, a reduced set of parameters representing the position and orientation of the user can be considered. For example, one or more of the parameters representing orientation can be removed and a nearest set of points are identified based on the mathematical distance from coordinates characterizing the position and orientation of the head of the user to one or more of the points from the set of points in the dimensional map 134. Examples of coordinates that can be removed include yaw, pitch, and/or roll angles. In one scenario, only the position of the head of the user and a yaw angle are considered, which reduces complexity to a consideration of four dimensions. As another example, only the position of the head of the user along with yaw and pitch angle are considered, which reduces complexity to five dimensions.

As another example, an alternative simplified approach to identifying transfer functions 132 includes reducing dimensionality of the dimensional map 134. As noted above, the dimensional map 134 includes a set of points in six-dimensional space to account for three parameters representing position and three parameters representing orientation. To reduce mathematical complexity, a dimensional map 134 that includes a set of points mapped in three, four, or five dimensional space can be generated and utilized. For example, the dimensional map 134 can map only the position of the head of the user in three-dimensional space and a yaw angle representing orientation, resulting in a four-dimensional map. As another example, the dimensional map 134 maps only the position of the head of the user and two parameters characterizing orientation, which reduces complexity of the dimensional map 134 to five dimensions.

As another example of a simplified approach to reducing dimensionality of the dimensional map 134, is to use multiple dimensional maps 134 that include three dimensions representing position in three-dimensional space can be utilized. Each of the three-dimensional maps are associated with a particular orientation parameter or a range of the orientation parameter. For example, each of the three-dimensional maps are associated with a yaw angle or a range of yaw angles. In one scenario, a first three-dimensional map is associated with a yaw angle of zero to ten degrees, a second three-dimensional map is associated with a yaw angle of greater than ten to twenty degrees, and so on. In this approach, based on a detected yaw angle of the head of the user, a three-dimensional map is selected. Then, based on coordinates based on the detected position of the user, the subset of points corresponding to nearest transfer functions 132 within the three-dimensional map are identified, weights of each transfer function are interpolated based on the barycentric distance or Euclidean distance to the detected position of the user, and the weighted transfer functions 132 are used to configure a filter 138.

The sensors 150 include various types of sensors that acquire data about the listening environment. For example, the computing device 110 can include auditory sensors to receive several types of sound (e.g., subsonic pulses, ultrasonic sounds, speech commands, etc.). In some embodiments, the sensors 150 includes other types of sensors. Other types of sensors include optical sensors, such as RGB cameras, time-of-flight cameras, infrared cameras, depth cameras, a quick response (QR) code tracking system, motion sensors, such as an accelerometer or an inertial measurement unit (IMU) (e.g., a three-axis accelerometer, gyroscopic sensor, and/or magnetometer), pressure sensors, and so forth. In addition, in some embodiments, sensor(s) 150 can include wireless sensors, including radio frequency (RF) sensors (e.g., sonar and radar), and/or wireless communications protocols, including Bluetooth, Bluetooth low energy (BLE), cellular protocols, and/or near-field communications (NFC). In various embodiments, the crosstalk cancellation application 120 uses the sensor data acquired by the sensors 150 to identify transfer functions 132 utilized for filters 138. For example, the computing device 110 includes one or more emitters that emit positioning signals, where the computing device 110 includes detectors that generate auditory data that includes the positioning signals. In some embodiments, the crosstalk cancellation application 120 combines multiple types of sensor data. For example, the crosstalk cancellation application 120 can combine auditory data and optical data (e.g., camera images or infrared data) in order to determine the position and orientation of the listener at a given time.

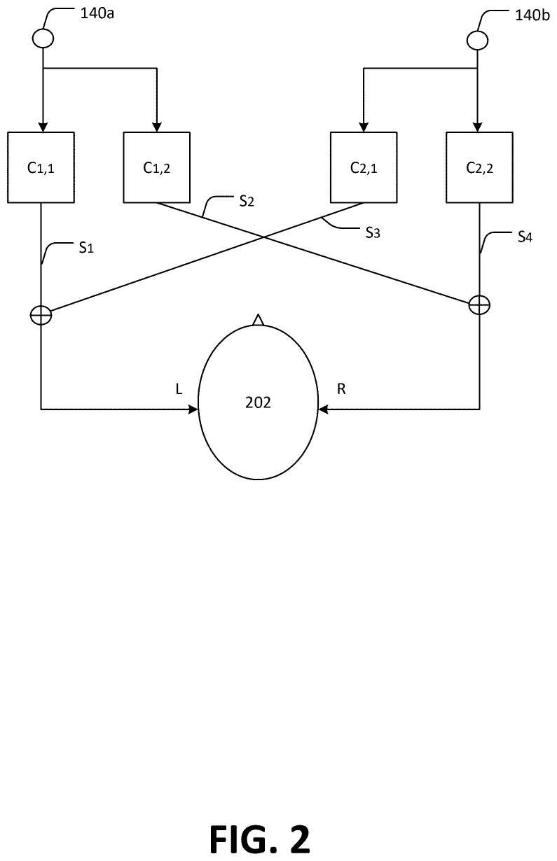

FIG. 2 illustrates an example of how crosstalk is observed by a user from an input signal that is produced by one or more speakers 160. When an audio source 140 is played back by one or more speakers 160 crosstalk can be measured within audio at a left ear L and right ear R of a listener 202. Crosstalk naturally occurs when speakers are remotely located from a listener 202 absent crosstalk cancellation. Audio source 140a represents a desired signal at the left ear of the listener 202, or a left channel of the audio source 140. Audio source 140b represents a desired signal at the right ear of the listener 202, or a right channel of the audio source 140. When audio is played back in an environment, such as by speakers 160 that are remotely located from the ears of the listener 202, crosstalk occurs. C_{1,1} and C_{1,2} represent functions that characterize how the environment affects audio source 140a when played back by audio processing system 100. S₁ and S₂ represent respective portions of the audio source 140a that are heard by the left and right ears of the listener 202, respectively. For example, when audio source 140a is played by corresponding one or more speakers 160, the environment alters audio source 140a according to C_{1,1} so that audio S₁ reaches the left ear of listener 202. Similarly, the environment alters audio source 140a according to C1,2 so that audio S₂ reaches the right ear of listener 202. S₂ represents a portion of audio source 140a that results in crosstalk that arrives at the right ear of the listener 202. C_{2,1} and C_{2,2} represent functions that characterize how the environment affects audio source 140b when played back by audio S₃ and S₄ represent respective portions of the audio source 140b that are heard by the left and right ears of the listener 202, respectively. For example, when audio source 140b is played by corresponding one or more speakers 160, the environment alters audio source 140b according to C_{2,2} so that audio S4 reaches the right ear of listener 202. Similarly, the environment alters audio source 140b according to C_{2,1} so that audio S₃ reaches the left ear of listener 202. S₃ represents a portion of audio source 140b that results in. Accordingly, embodiments of the disclosure utilize filters 138 that process signals that are then used to drive one or more speakers 160 to reduce or eliminate crosstalk caused by the environment.

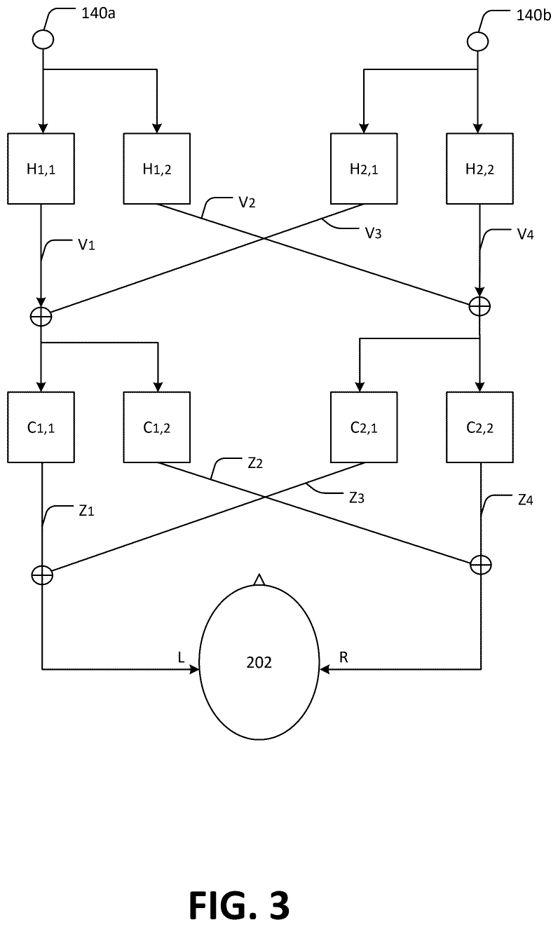

FIG. 3 illustrates an example of filters 138 that perform crosstalk cancellation based upon an observed position and orientation of a user within a three-dimensional space according to various embodiments of the disclosure. As shown in FIG. 3, the audio source 140a corresponding to a left channel of audio source 140, and audio source 140b, corresponding to the right channel of audio source 140, are played back by one or more speakers 160. As described above in connection with FIG. 2, audio source 140a represents a desired signal at the left ear of the listener 202, or a left channel of the audio source 140. Audio source 140b represents a desired signal at the right ear of the listener 202, or a right channel of the audio source 140. Without filtering, when audio is played back in a three-dimensional environment, such as by speakers 160 that are remotely located from the ears of the listener 202, crosstalk can occur as described in FIG. 2.

Crosstalk cancellation application 120 determines the position and orientation of the head of the listener 202 based on sensor data from sensors 150, such as one or more cameras or other devices that detect a position or orientation of the listener 202. Crosstalk cancellation application 120 further determines, based on a dimensional map 134, the distance of the parameters characterizing the position and orientation of head of the listener 202 to one or more points within the dimensional map 134. In one example, crosstalk cancellation application 120 calculates a mathematical distance, such as a barycentric distance or a Euclidean distance, of the position and orientation of the head of the listener 202 from points within the dimensional map 134. The crosstalk cancellation application 120 then identifies transfer functions 132 associated with the nearest point according to the calculated barycentric or Euclidean distance.

The crosstalk cancellation application 120 selects transfer functions that are used to configure a set of filters that filter the portions of audio source 140a and 140b that are played back by one or more speakers 160 to reduce or eliminate crosstalk from the portion of the audio signals Z₁, Z₂, Z₃, and Z₄ that arrive at the left and right ears of the listener 202. As shown in FIG. 3, filters H_{1,1} and H_{1,2} filter portions of audio source 140a and filters H_{2,1} and H_{2,2} filter portions of audio source 140b so that when the audio source 140 is output in an environment that affects played back signals according to C_{1,1}, C_{1,2}, C_{2,1}, and C_{2,2}, crosstalk is reduced or eliminated.

V₁ and V₂ represent respective filtered portions of the audio source 140a that are filtered by filters H_{1,1} and H_{1,2}, and output to one or more speakers 160, respectively. V₃ and V₄ represent respective filtered portions of the audio source 140b that are filtered by filters H_{2,1} and H_{2,2}, and output to one or more speakers 160, respectively. Therefore, when environment alters the signals output by the filters and played back by one or more speakers 160 according to C_{1,1}, C_{1,2}, C_{2,1}, and C_{2,2}, the signals reaching the ears of the listener 202 have reduced or eliminated crosstalk. As shown in FIG. 3, H_{1,1} and H_{1,2} filter audio source 140a to produce V₁ and V₂ that are played back by one or more speakers 160 so that, when subjected to the effects of the environment by C_{1,1} and C_{2,1}, resultant signals Z₁ and Z₃ arriving at the left ear of the listener 202 correspond only to audio source 140a, the left channel of the audio source 140. Similarly, H_{2,1} and H_{2,2} filter audio source 140b to produce V₃ and V₄ that are played back by one or more speakers 160 so that, when subjected to the effects of the environment by C_{1,2} and C_{2,2}, resultant signals Z₂ and Z₄ arriving at the right ear of the listener 202 correspond only to audio source 140b, the right channel.

Example of techniques to determine and/or select transfer functions 132 that are used to configure a set of filters H_{1,1}, H_{1,2}, H_{2,1}, and H_{2,2} that filter audio source 140a and audio source 140b based on the position and orientation of the listener 202 can be found in concurrently filed application titled “MULTIDIMENSIONAL ACOUSTIC CROSSTALK CANCELLATION FILTER INTERPOLATION” having Attorney Docket number “HRMN0487US1 (P230497US)” and concurrently filed application titled “ACOUSTIC CROSSTALK CANCELLATION BASED UPON USER POSITION AND ORIENTATION WITHIN AN ENVIRONMENT” having Attorney Docket number “HRMN0491US1 (P230502US)”. The position and orientation of the listener 202 are determined based upon sensor data from one or more sensors 150. As the position and/or orientation of the listener 202 changes, crosstalk cancellation application 120 updates the transfer functions 132 used to configure the filters H_{1,1}, H_{1,2}, H_{2,1}, and H_{2,2} by determining whether the movement of the listener 202 to an updated position or orientation corresponds to a different set of transfer functions 132 defined by the dimensional map 134. In this way, the crosstalk cancellation application 120 performs crosstalk cancellation based on the current position and orientation of the listener 202 as well as when the listener 202 adjusts position and/or orientation within a given three-dimensional space characterized by the dimensional map 134.

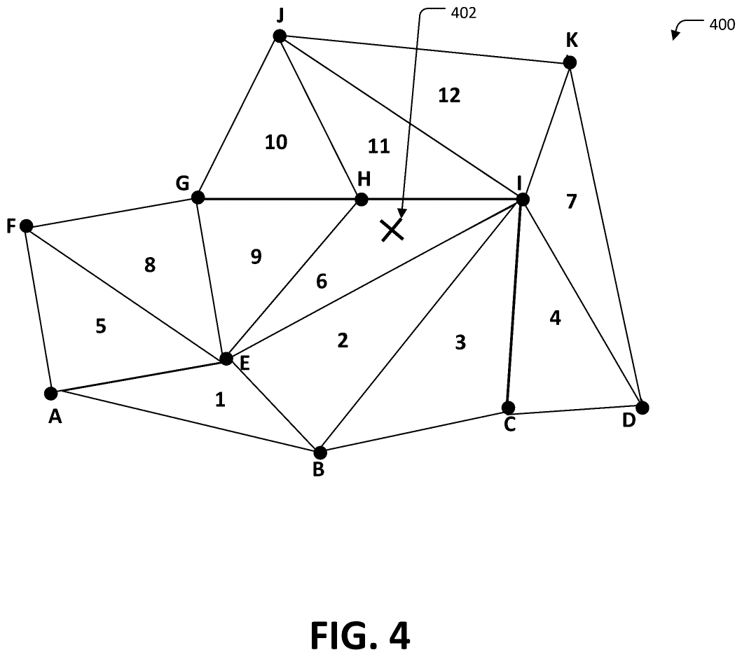

FIG. 4 illustrates an example dimensional map 400 based on the starting position and orientation 402 of the listener, according to various embodiments. As shown in FIG. 4, a dimensional map 400 is shown in two dimensions (e.g., x and y dimensions) that includes a set of points representing different transfer functions, such as transfer functions 132, that are effective at minimizing or eliminating crosstalk at a specific position and/or orientation in an environment. The dimensional map 400 includes triangulations (e.g., Delaunay triangulation) of various subsets of points in polygonal spaces, such that a circumscribed hypersphere of each polygonal space does not contain any other point in the dimensional map 400 and that each polygonal space is non-overlapping. For example, dimensional map 400 includes polygonal spaces, such as the triangles labeled 1-12, formed by the various subsets of points labeled A-K, where each triangle is non-overlapping and contains no other point in the dimensional map. Dimensional map 400 also includes the starting position and orientation 402 of the listener, which represents the position and/or orientation of the listener in the environment. For illustrative purposes the depiction of dimensional map 400 in FIG. 4 includes only two dimensions, and therefore the polygonal spaces are triangles, however the dimensional map 400 can include as many technically feasible dimensions necessary to track the position and orientation of the listener and is not meant to be limiting in any way. In various embodiments, the crosstalk cancellation application 120 determines a starting position and orientation 402 of the listener based on data from sensors 150.

In some embodiments, the dimensional map 400 is stored in memory 114 of computing device 110, such as dimensional map 134. In some embodiments, dimensional map 400 maps a given position and orientation within a three-dimensional space, such as a vehicle interior, to filter parameters for one or more filters 138, such as one or more FIR filters. In the example shown in FIG. 4, the dimensional map 400 is preconfigured to only include points from the complete dimensional map 180 whose associated polygonal shape (e.g., triangle) has a point in common with the polygonal shape that contains a starting position and orientation 402 of the listener (i.e., the triangle labeled 6). Each other polygonal shape in dimensional map 134 shares a point in common with the polygonal shape labeled 6, which is associated with the starting position and orientation 402 of the listener. The above pre-configuration of dimensional map 400 is illustrated in Figure for example purposes only and not meant to be limiting in any way. Other technically feasible pre-configuration techniques can be used to generate dimensional map 400.

For example, in some embodiments, the dimensional map 400 is preconfigured to only include a subset of points from the complete dimensional map 180 that are within a predefined distance threshold range (e.g., 50 cm, 20 cm, 10 cm, etc.) from the starting position and orientation of the listener in each dimension. In the case of a three-dimensional map and a predefined range of 20 cm, if the starting position and orientation of the listener is at coordinate (5, 10, 12), the-dimensional map 400 is preconfigured to only include points within the range of (−20, −10, −12) to (25, 30, 32). In some embodiments, dimensional map 400 is preconfigured to include a predetermined number (e.g., less than 100) of the points from the complete dimensional map 180 in six dimensions (e.g., three dimensions for position and three dimensions for orientation) or less that are closest to the starting position and orientation 402 of the listener. The crosstalk cancellation application 120 can adds or removes points from the dimensional map 400 based on the starting position and orientation 402 of the listener.

Although dimensional map 400 is preconfigured to include polygonal shapes that have a point in common with the polygonal shape labeled 6, more polygonal shapes can be included depending on the expected trajectory of the listener. For example, in the environment of the interior of an automobile, it is unlikely that the head of the listener will move drastically. By preconfiguring the dimensional map 400 to only include polygonal shapes near the starting position and orientation 402 of the listener, and the corresponding points and associated transfer functions, compared to the hundreds or thousands of possible points and associated transfer functions for the entire environment in the complete dimensional map 180, the memory constraint on the computing device is severely reduced.

Once the initial dimensional map 400 is determined by crosstalk cancellation application 120, the crosstalk cancellation application 120 identifies transfer functions 132 associated with the nearest points to the starting position and orientation 402 of listener based on a calculated barycentric or Euclidean distance. The transfer functions can then be used to configure filters 138 as further described in FIG. 3.

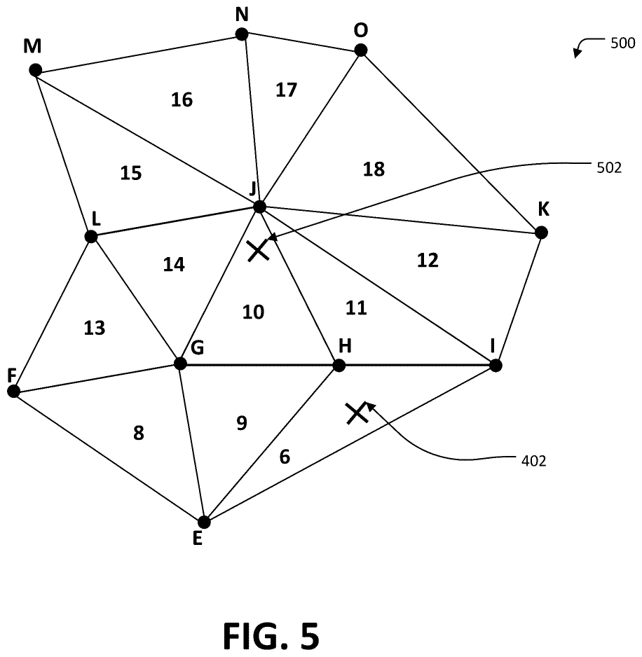

FIG. 5 illustrates an example dimensional map 500 that has been updated based on a new position and orientation 502 of a listener, according to one or more embodiments. The new position and orientation 502 of the listener can be based on a new current position and orientation of the listener or based on a projected position and orientation of the listener using the trajectory of the listener. Dimensional map 500 is an updated version of dimensional map 400 shown in FIG. 4. As shown in FIG. 5, dimensional map 500 is shown in two dimensions (e.g., x and y dimensions) that includes a set of points representing different transfer functions, such as transfer functions 132, that are effective at minimizing or eliminating crosstalk at a specific position and/or orientation in an environment. The dimensional map 500 includes triangulations (e.g., Delaunay triangulation) of various subsets of points in polygonal spaces, such that a circumscribed hypersphere of each polygonal space does not contain any other point in the dimensional map 400 and that each polygonal space is non-overlapping. For example, dimensional map 500 includes polygonal spaces, such as the triangles labeled 6, and 8-17, formed by the various subsets of points E-O, where each triangle is non-overlapping and contains no other point in the dimensional map. Dimensional map 500 also includes the starting position and orientation 402 of the listener, which represents the position and/or orientation of the listener in the environment, and new position and orientation 502 of the listener which represents the new position and/or orientation of the listener in the environment. For illustrative purposes the depiction of dimensional map 500 in FIG. 5 includes only two dimensions, and therefore the polygonal spaces are triangles, however the dimensional map 500 can include as many technically feasible dimensions necessary to track the position and orientation of the listener and is not meant to be limiting in any way.

In some embodiments, the dimensional map 500 is stored in memory 114 of computing device 110, such as dimensional map 134. In some embodiments, dimensional map 500 maps a given position and orientation within a three-dimensional space, such as a vehicle interior, to filter parameters for one or more filters 138, such as one or more FIR filters. During playback of the audio source 140, the position or orientation of the head of the listener changes may change. The crosstalk cancellation application 120 uses data from the one or more sensors 150 to determine that the position and/or orientation of the listener has changed to the new position and orientation 502 of the listener.

In the example shown in FIG. 5, the dimensional map 500 is an updated version of dimensional map 400 which includes points from the complete dimensional map 180 whose associated polygonal shape (e.g., triangle) has a point in common with the polygonal shape that contains the new position and orientation 502 of the listener (i.e., the triangle labeled 10). Additionally, the dimensional map 500 is updated to remove points that were included in dimensional map 400 of FIG. 4 that do not have a point in common with the polygonal shape that contains the new position and orientation 502 of the listener (i.e., the triangle labeled 10).

For example, the polygonal shapes labeled 6, 8-9, and 11-18 in dimensional map 500 share a point in common with the polygonal shape labeled 10, which is associated with the new position and orientation 502 of the listener. When compared with dimensional map 400 in FIG. 4, dimensional map 500 has added points labeled L-O and the associated polygonal shapes labeled 13-18 and removed points A-D and associated polygonal shapes 1-5 and 7. The above techniques to update dimensional maps as illustrated in FIG. 5 is for example purposes only and not meant to be limiting in any way. Other technically feasible update techniques can be used to generate dimensional map 500 from dimensional map 400.

For example, in some embodiments, the crosstalk cancellation application 120 can update dimensional map 400 to generate dimensional map 500 based determining a trajectory of the listener based on the difference between the starting position and orientation 402 of the listener and the new position and orientation 502 of the listener or by fitting a spline or other curve to recent positions and orientations of the listener. Based on the trajectory of the listener and/or the new position and orientation 502 of the listener, the crosstalk cancellation application 120 updates the dimensional map 400 to generate dimensional map 500 by adding points associated with transfer functions expected to be near the new position and orientation 502 of the listener and/or around the trajectory and removing points associated with transfer functions that are expected to be farther from the new position and orientation 502 of the listener and/or outside of the trajectory. For example, in the environment of the interior of an automobile, if the head of the listener is moving in one direction it is unlikely that the head of the listener will move drastically in another direction. By updating the dimensional map to include points with associated transfer functions and corresponding polygonal shapes near the new position and orientation 502 of the listener and/or within the trajectory and remove points associated with transfer functions and corresponding polygonal shapes farther away from the new position and orientation 502 of the listener and/or outside the trajectory, the memory constraint on the computing device is severely reduced.

As another example, in some embodiments, the crosstalk cancellation application 120 can search the complete dimensional map 180 for additional points to update the dimensional map 400 to generate dimensional map 500 by using graph theory branch and bound algorithms, such as the A* algorithm, AO* algorithm, nearest neighbors algorithm, or any other technically feasible algorithm that can search for additional points in the complete dimensional map 180 based on a heuristic measurement, such as a new position and orientation 502 of the listener.

By continually adding relevant points and corresponding polygonal shapes and removing no longer relevant points and corresponding polygonal shapes, the crosstalk cancellation application 120 saves both time and resources, such as memory, during playback of the audio source 140. For example, because dimensional map 500 includes the points and corresponding polygonal shapes associated with the transfer functions 132 nearest the new position and orientation 502 of the listener, the crosstalk cancellation application 120 can search the dimensional map 500 for the nearest points to the position and orientation 502 of the listener faster and more efficiently. Additionally, as stated previously, storing the dimensional map 400 and 500 takes up less memory than a dimensional map that contains all possible points the listener potentially be near.

Once the updated dimensional map 500 is determined by crosstalk cancellation application 120, the crosstalk cancellation application 120 identifies transfer functions 132 associated with the nearest points to the new position of listener 502 based on a calculated barycentric or Euclidean distance. The transfer functions can then be used to configure filters 138 as further described in FIG. 3.

During further playback of the audio source 140, the position or orientation of the head of the listener may change again. In such a case, another updated dimensional map (not shown) can be determined by the crosstalk cancellation application 120 in a similar manner as described above. Each time the position or orientation of the head of the listener changes, the crosstalk cancellation application 120 can keep determining another updated dimensional map in a similar manner. In some embodiments, the audio processing system 100 can store previously used transfer functions 132 and filters 138 for quick access in the case that the position or orientation of the head of the listener changes to a previous position and/or orientation already defined by the sensors 150. In such a case, the crosstalk cancellation application 120 still updates the dimensional map in a similar manner described above, but the crosstalk cancellation application 120 can use the previously stored transfer functions 132 and filters 138 without needing to search the dimensional map.

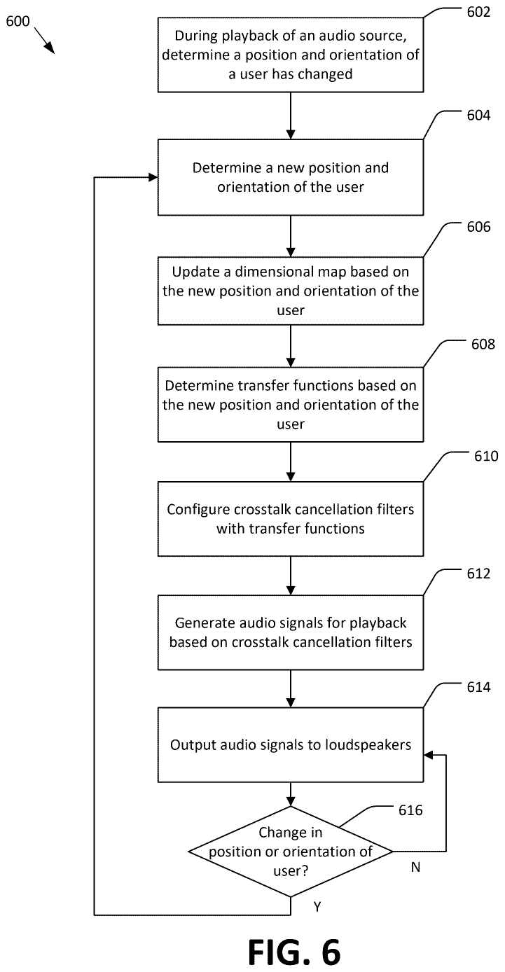

FIG. 6 illustrates a flow chart of method steps for determining crosstalk cancellation filters when a listener changes position in real-time according to one or more embodiments. Although the method steps are described with reference to the embodiments of FIGS. 1-5, persons skilled in the art will understand that any system configured to implement the method steps, in any order, falls within the scope of the present disclosure.

Method 600 begins at step 602, where during playback of the audio source 140, the crosstalk cancellation application 120 determines that the position and orientation of a user within an environment has changed. The environment includes a space in which audio is played back by one or more speakers 160, such as the interior of a vehicle or any other interior or exterior environment. Crosstalk cancellation application 120 previously determined a prior position and orientation of the listener 202, such as the starting position and orientation 402 of the listener, based upon sensor data obtained from sensors 150 associated with an audio processing system 100. As noted above, the sensors 150 include optical sensors, pressure sensors, proximity sensors, and other sensors that obtain information about the environment and the position and orientation of the listener 202 within the environment. In some embodiments, the sensors 150 can notify the crosstalk cancellation application 120 that the position and orientation of the user has changed.

At step 604, the crosstalk cancellation application 120 determines the new position and orientation of the user, such as new position and orientation 502 of the listener. The new position of the listener is determined relative to a reference position within the environment based upon sensor data from the sensors 150. The orientation of the listener is also determined relative to a reference orientation within the environment. In some embodiments, crosstalk cancellation application 120 determines the position and orientation of the head and/or ears of the listener 202 based upon the sensor data. Alternatively, the crosstalk cancellation application 120 can determine the new position and orientation of the listener based on a trajectory of the listener.

At step 606, the crosstalk cancellation application 120 updates the dimensional map, such as updating the dimensional map 400 to generate dimensional map 500, based on the new position and orientation 502 of the listener. the dimensional map 500 is an updated version of dimensional map 400 which includes points from the complete dimensional map 180 whose associated polygonal shape (e.g., triangle) has a point in common with the polygonal shape that contains the new position and orientation 502 of the listener (i.e., the triangle labeled 10). Additionally, the dimensional map 500 is updated to remove points that were included in a previous version of the dimensional map (e.g., dimensional map 400 of FIG. 4) that do not have a point in common with the polygonal shape that contains the new position and orientation 502 of the listener (i.e., the triangle labeled 10). For example, the polygonal shapes labeled 6, 8-9, and 11-18 in dimensional map 500 share a point in common with the polygonal shape labeled 10, which is associated with the new position and orientation 502 of the listener.

In some embodiments, the crosstalk cancellation application 120 can update dimensional map 400 to generate dimensional map 500 based determining a trajectory of the listener based on the difference between the starting position and orientation 402 of the listener and the new position and orientation 502 of the listener or by fitting a spline or other curve to recent positions and orientations of the listener. Based on the trajectory of the listener and/or the new position and orientation 502 of the listener, the crosstalk cancellation application 120 updates the dimensional map 400 to generate dimensional map 500 by adding points associated with transfer functions expected to be near the new position and orientation 502 of the listener and/or around the trajectory and removing points associated with transfer functions that are expected to be farther from the new position and orientation 502 of the listener and/or outside of the trajectory. In some embodiments, the crosstalk cancellation application 120 can search the complete dimensional map 180 for additional points to update the dimensional map 400 to generate dimensional map 500 by using graph theory branch and bound algorithms, such as the A* algorithm, AO* algorithm, nearest neighbors algorithm, or any other technically feasible algorithm that can search for additional points in the complete dimensional map 180 based on a heuristic measurement, such as a new position and orientation 502 of the listener.

At step 608, crosstalk cancellation application 120 crosstalk cancellation application 120 determines transfer functions based on the new position and orientation 502 of the user in the updated dimensional map 134. In some embodiments, the transfer functions are the transfer functions associated with the point in the dimensional map closest to the new position and orientation 502 of the user. In some embodiments, the transfer functions are determined based on weighted sums of the transfer functions associated with the nearest set of points to the new position and orientation 502 of the user within the dimensional map 134. For example, the nearest set of points could include the vertices of the triangle in which the new position and orientation 502 of the listener is located, such as points G, H, and J from the dimensional map 500.

In some embodiments, crosstalk cancellation application 120 selects transfer functions 132 associated with the closest point(s) in the dimensional map 134 to configure filters 138 that filter the audio source 140 that is played back. In other embodiments, a simplified approach to identifying a point based on the new position and orientation 502 of the listener includes reducing the number of dimensions of the new position and orientation 502 of the listener that are considered when identifying a point associated with the listener 202 in the dimensional map 500. To reduce mathematical complexity, a reduced set of parameters representing the new position and orientation of the user can be considered. For example, one or more of the parameters representing orientation can be removed and a nearest set of points are identified based on the mathematical distance from coordinates characterizing the position and orientation of the head of the user to one or more of the points from the set of points in the dimensional map 500. Examples of coordinates that can be removed include yaw, pitch, and/or roll angles. As another example, an alternative simplified approach to identifying transfer functions 132 includes reducing dimensionality of the dimensional map 500. As noted above, the dimensional map 500 includes a set of points in two-dimensional space, but dimensional maps can include a set of points in any technically feasible dimensional space. For example, six-dimensional space can account for three parameters representing position and three parameters representing orientation. To reduce mathematical complexity, a dimensional map that includes a set of points mapped in three, four, or five dimensional space can be generated and utilized. For example, the dimensional map can map only the position of the user's head in three-dimensional space and a yaw angle representing orientation, resulting in a four-dimensional map. As another example, the dimensional map can map only the position of the user's head and two parameters characterizing orientation, which reduces complexity of the dimensional map to five dimensions. In any of the above scenarios, the crosstalk cancellation application 120 identifies a point within the dimensional map 500 that is closest to the point characterizing at least some parameters corresponding to the new position and orientation 502 of the listener.

At step 610, crosstalk cancellation application 120 configures the one or more filters 138 using the transfer functions 132 determined at step 608. Crosstalk cancellation application 120 applies the transfer functions 132 to the filters 138 that are used to filter audio signals that are in turn provided to one or more speakers 160 for playback within the environment.

At step 612, crosstalk cancellation application 120 generates audio signals for playback based on the filters 138 configured with the identified transfer functions 132. The audio signals are generated based upon an audio source 140 that is being played back by audio processing system 100 within the environment, such as a song or other audio input provided to the audio processing system 100. The audio source 140 includes a left channel and a right channel. Crosstalk cancellation application 120 filters the audio source 140 using the filters 138 that are configured with the transfer functions 132 that were selected based upon the new position and orientation 502 of the listener. When played back in the environment, the filtered audio signals arrive at the left and right ear of the listener 202, respectively, with crosstalk being reduced or eliminated.

At step 614, crosstalk cancellation application 120 outputs the filtered audio signals to one or more speakers 160 associated with audio processing system 100. One or more speakers 160 play back the filtered audio signals in the environment based on the filtered audio signals.

The one or more speakers 160 include one or more speakers corresponding to a left channel of the audio processing system 100 and one or more speakers corresponding to a right channel of the audio processing system 100.

At step 616, crosstalk cancellation application 120 determines whether there is another change in the position or orientation of the listener 202. If there is another change in the position or orientation of the listener 202, method 600 returns to step 604, where crosstalk cancellation application 120 determines a new position and orientation of the listener 202 and identifies new transfer functions 132 with which to update the filters 138. If the position and orientation of the listener 202 is unchanged, the method 600 returns to step 614, where crosstalk cancellation application 120 continues to output audio signals based on crosstalk cancellation application 120 using the transfer functions 132 identified at step 608.

In sum, a crosstalk cancellation application 120 configures a set of filters based on tracking the position and location of a listener 202, which are utilized to perform crosstalk cancellation, in real-time, between the left and right channels of an audio source 140 that is played back by one or more speakers 160. When the listener 202 in an environment moves, the crosstalk cancellation application 120 identifies the new position and orientation of the head of the listener within a three-dimensional space using sensor data from one or more sensors 150. A complete dimensional map 180 specifies a set of points for the environment that are respectively associated with transfer functions 132 that are used to configure the filters 138 for crosstalk cancellation. Based upon the new position and orientation of the listener, the crosstalk cancellation application 120 generates or updates the dimensional map 134 from the complete dimensional map 180. The crosstalk cancellation application 120 determines a new set of points in the dimensional map 134 that are respectively associated with transfer functions 132 that are used to configure new filters 138 based on the new position and orientation of the head of the listener. The filters 138, utilizing the new transfer functions 132, filter one or more signals corresponding to an audio source 140 that are used to drive one or more speakers 160 to create a sound field. The one or more speakers 160 play back respective filtered signals. When altered by the environment, the filtered signals, once reaching the ears of the listener, have reduced or eliminated crosstalk.

At least one technical advantage of the disclosed techniques relative to the prior art is that, with the disclosed techniques, an audio processing system can minimize the amount of memory required for real-time, dynamic crosstalk cancellation. For example, the disclosed techniques allow the audio processing system to load audio measurements and/or the crosstalk cancellation filters into RAM in a separate processing thread. Furthermore, by using a separate processing thread, the audio processing system can implement real-time, dynamic crosstalk cancellation techniques faster than conventional techniques. These technical advantages provide one or more technological advancements over prior art approaches.
1. In some embodiments, a method comprises determining a new position and a new orientation of a user; updating, based on the new position and the new orientation of the user, a dimensional map, wherein the dimensional map includes a set of points in a multi-dimensional space and each point is associated with a corresponding transfer function; identifying, based on the new position and the new orientation of the user, a point in the updated dimensional map nearest to the new position and the new orientation of the user; configuring, based on at least the transfer function associated with the point nearest to the new position and the new orientation of the user, at least one crosstalk cancellation filter; generating a plurality of audio signals for a plurality of loudspeakers based on the at least one crosstalk cancelation filter; and transmitting the plurality of audio signals to the plurality of loudspeakers for output.
2. The computer-implemented method of clause 1, wherein determining the new position and the new orientation of the user comprises receiving sensor data from a plurality of sensors.
3. The computer-implemented method of either clause 1 or 2, wherein determining the new position and the new orientation of the user comprises projecting along a trajectory of the user.
4. The computer-implemented method of any of clauses 1-3, wherein determining the new position and the new orientation of the user comprises calculating three coordinates corresponding to a position relative to a reference position and three coordinates corresponding to an orientation relative to a reference orientation.
5. The computer-implemented method of any of clauses 1-4, wherein updating the dimensional map comprises: adding a first plurality of points associated with a first plurality of transfer functions to the set of points based on the first plurality of points based on the new position and new orientation of the user; and removing a second plurality of points associated with a second plurality of transfer functions in the set of points based on the new position and new orientation of the user.
6. The computer-implemented method of clause 5, wherein adding the first plurality of points to the set of points comprises loading the first plurality of points and the associated first plurality of transfer functions from a complete dimensional map stored in a data store.
7. The computer-implemented method of any of clauses 1-6, wherein updating the dimensional map comprises: removing a plurality of points in the set of points from the dimensional map based on a location of the plurality of points being outside a distance threshold from the new position and new orientation of the user.
8. The computer-implemented method of any of clauses 1-7, wherein updating the dimensional map comprises: searching, based on a branch and bound algorithm and the new position and new orientation of the user, a second dimensional map for a plurality of points associated with a plurality of transfer functions near the new position and the new orientation; and adding the plurality of points associated with the plurality of transfer functions to the set of points.
9. The computer-implemented method of any of clauses 1-8, wherein the dimensional map includes non-overlapping polygonal spaces for each subset of points in the dimensional map, wherein each vertex of each non-overlapping polygonal space is a different point included in the set of points, and wherein a circumscribed hypersphere of each non-overlapping polygonal space contains only points within the associated set of points.
10. The computer-implemented method of clause 8, wherein the non-overlapping polygonal spaces are generated based on Delaunay triangulation.
11. The computer-implemented method of any of clauses 1-10, wherein the dimensional map is selected from a plurality of dimensional maps, wherein the dimensional map is selected based on a yaw angle relative to a reference orientation that corresponds to the first orientation.
12. The computer-implemented method of clause 11, wherein each of the plurality of dimensional maps is associated with a range of yaw angles relative to the reference orientation.
13. The computer-implemented method of any of clauses 1-12, wherein the set of points is limited to a predetermined number of points.
14. In some embodiments, one or more non-transitory computer-readable media storing instructions that, when executed by one or more processors, cause the one or more processors to perform the steps of: determining a new position and a new orientation of a user; updating, based on the new position and the new orientation of the user, a dimensional map, wherein the dimensional map includes a set of points in a multi-dimensional space and each point is associated with a corresponding transfer function; identifying, based on the new position and the new orientation of the user, a point in the updated dimensional map nearest to the new position and the new orientation of the user; configuring, based on at least the transfer function associated with the point nearest to the new position and the new orientation of the user, at least one crosstalk cancellation filter; generating a plurality of audio signals for a plurality of loudspeakers based on the at least one crosstalk cancelation filter; and transmitting the plurality of audio signals to the plurality of loudspeakers for output.
15. The one or more non-transitory computer-readable media of clause 14, wherein the step of determining the new position and the new orientation of the user is performed by receiving sensor data from a plurality of sensors.
16. The one or more non-transitory computer-readable media of either clause 14 or 15, wherein the step of determining the new position and the new orientation of the user is performed by projecting along a trajectory of the user.
17. The one or more non-transitory computer-readable media of any of clauses 14-16, wherein the step of updating the dimensional map is performed by: adding a first plurality of points associated with a first plurality of transfer functions to the set of points based on the first plurality of points based on the new position and new orientation of the user; and removing a second plurality of points associated with a second plurality of transfer functions in the set of points based on the new position and new orientation of the user.
18. The one or more non-transitory computer-readable media of clause 17, wherein the step of adding the first plurality of points to the set of points is performed by loading the first plurality of points and the associated first plurality of transfer functions from a complete dimensional map stored in a data store.
19. The one or more non-transitory computer-readable media of any of clauses 14-18, wherein the step of updating the dimensional map is performed by: removing a plurality of points in the set of points from the dimensional map based on a location of the plurality of points being outside a distance threshold from the new position and new orientation of the user.
20. In some embodiments, a system comprises: at least one sensor configured to obtain information about a user in an environment; at least one speaker configured to play back audio within the environment; a memory storing crosstalk cancellation application; and a processor coupled to the memory that executes the crosstalk cancellation application by performing the steps of: determining a new position and a new orientation of a user; updating, based on the new position and the new orientation of the user, a dimensional map, wherein the dimensional map includes a set of points in a multi-dimensional space and each point is associated with a corresponding transfer function; identifying, based on the new position and the new orientation of the user, a point in the updated dimensional map nearest to the new position and the new orientation of the user; configuring, based on at least the transfer function associated with the point nearest to the new position and the new orientation of the user, at least one crosstalk cancellation filter; generating a plurality of audio signals for a plurality of loudspeakers based on the at least one crosstalk cancelation filter; and transmitting the plurality of audio signals to the plurality of loudspeakers for output.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
determining a new position and a new orientation of a user;
updating, based on the new position and the new orientation of the user, a dimensional map, wherein the dimensional map includes a set of points in a multi-dimensional space and each point is associated with a corresponding transfer function;
identifying, based on the new position and the new orientation of the user, a point in the updated dimensional map nearest to the new position and the new orientation of the user;
configuring, based on at least the transfer function associated with the point nearest to the new position and the new orientation of the user, at least one crosstalk cancellation filter;
generating a plurality of audio signals for a plurality of loudspeakers based on the at least one crosstalk cancelation filter; and
transmitting the plurality of audio signals to the plurality of loudspeakers for output.

2. The computer-implemented method of claim 1, wherein determining the new position and the new orientation of the user comprises receiving sensor data from a plurality of sensors.

3. The computer-implemented method of claim 1, wherein determining the new position and the new orientation of the user comprises projecting along a trajectory of the user.

4. The computer-implemented method of claim 1, wherein determining the new position and the new orientation of the user comprises calculating three coordinates corresponding to a position relative to a reference position and three coordinates corresponding to an orientation relative to a reference orientation.

5. The computer-implemented method of claim 1, wherein updating the dimensional map comprises:
adding a first plurality of points associated with a first plurality of transfer functions to the set of points based on the first plurality of points based on the new position and new orientation of the user; and
removing a second plurality of points associated with a second plurality of transfer functions in the set of points based on the new position and new orientation of the user.

6. The computer-implemented method of claim 5, wherein adding the first plurality of points to the set of points comprises loading the first plurality of points and the associated first plurality of transfer functions from a complete dimensional map stored in a data store.

7. The computer-implemented method of claim 1, wherein updating the dimensional map comprises:
removing a plurality of points in the set of points from the dimensional map based on a location of the plurality of points being outside a distance threshold from the new position and new orientation of the user.

8. The computer-implemented method of claim 1, wherein updating the dimensional map comprises:
searching, based on a branch and bound algorithm and the new position and new orientation of the user, a second dimensional map for a plurality of points associated with a plurality of transfer functions near the new position and the new orientation; and
adding the plurality of points associated with the plurality of transfer functions to the set of points.

9. The computer-implemented method of claim 1, wherein the dimensional map includes non-overlapping polygonal spaces for each subset of points in the dimensional map, wherein each vertex of each non-overlapping polygonal space is a different point included in the set of points, and wherein a circumscribed hypersphere of each non-overlapping polygonal space contains only points within the associated set of points.

10. The computer-implemented method of claim 9, wherein the non-overlapping polygonal spaces are generated based on Delaunay triangulation.

11. The computer-implemented method of claim 1, wherein the dimensional map is selected from a plurality of dimensional maps, wherein the dimensional map is selected based on a yaw angle relative to a reference orientation that corresponds to the first orientation.

12. The computer-implemented method of claim 11, wherein each of the plurality of dimensional maps is associated with a range of yaw angles relative to the reference orientation.

13. The computer-implemented method of claim 1, wherein the set of points is limited to a predetermined number of points.

14. One or more non-transitory computer-readable media storing instructions that, when executed by one or more processors, cause the one or more processors to perform the steps of:
determining a new position and a new orientation of a user;
updating, based on the new position and the new orientation of the user, a dimensional map, wherein the dimensional map includes a set of points in a multi-dimensional space and each point is associated with a corresponding transfer function;
identifying, based on the new position and the new orientation of the user, a point in the updated dimensional map nearest to the new position and the new orientation of the user;
configuring, based on at least the transfer function associated with the point nearest to the new position and the new orientation of the user, at least one crosstalk cancellation filter;
generating a plurality of audio signals for a plurality of loudspeakers based on the at least one crosstalk cancelation filter; and
transmitting the plurality of audio signals to the plurality of loudspeakers for output.

15. The one or more non-transitory computer-readable media of claim 14, wherein the step of determining the new position and the new orientation of the user is performed by receiving sensor data from a plurality of sensors.

16. The one or more non-transitory computer-readable media of claim 14, wherein the step of determining the new position and the new orientation of the user is performed by projecting along a trajectory of the user.

17. The one or more non-transitory computer-readable media of claim 14, wherein the step of updating the dimensional map is performed by:
adding a first plurality of points associated with a first plurality of transfer functions to the set of points based on the first plurality of points based on the new position and new orientation of the user; and
removing a second plurality of points associated with a second plurality of transfer functions in the set of points based on the new position and new orientation of the user.

18. The one or more non-transitory computer-readable media of claim 17, wherein the step of adding the first plurality of points to the set of points is performed by loading the first plurality of points and the associated first plurality of transfer functions from a complete dimensional map stored in a data store.

19. The one or more non-transitory computer-readable media of claim 14, wherein the step of updating the dimensional map is performed by:
removing a plurality of points in the set of points from the dimensional map based on a location of the plurality of points being outside a distance threshold from the new position and new orientation of the user.

20. A system comprising:
at least one sensor configured to obtain information about a user in an environment;
at least one speaker configured to play back audio within the environment;
a memory storing crosstalk cancellation application; and
a processor coupled to the memory that executes the crosstalk cancellation application by performing the steps of:
determining a new position and a new orientation of a user;
updating, based on the new position and the new orientation of the user, a dimensional map, wherein the dimensional map includes a set of points in a multi-dimensional space and each point is associated with a corresponding transfer function;
identifying, based on the new position and the new orientation of the user, a point in the updated dimensional map nearest to the new position and the new orientation of the user;
configuring, based on at least the transfer function associated with the point nearest to the new position and the new orientation of the user, at least one crosstalk cancellation filter;
generating a plurality of audio signals for a plurality of loudspeakers based on the at least one crosstalk cancelation filter; and
transmitting the plurality of audio signals to the plurality of loudspeakers for output.
